(19) United States
(12) Patent Application Publication
(10) Pub. No.: US 2015/0296415 A1
(43) Pub. Date: Oct. 15, 2015

(54) Ack For Downlink WiFi Carrier Aggregation

(71) Applicant: Alcatel Lucent, Paris (FR)

(72) Inventors: Jonathan Ling, North Brunswick, NJ (US); Satish Kanugovi, Bangalore (IN); Subramanian Vasudevan, Morristown, NJ (US)

(73) Assignee: Alcatel Lucent, Paris (FR)

(21) Appl. No.: 14/250,845

(22) Filed: Apr. 11, 2014

(51) Int. Cl. H04W 28/12; H04L 12/801; H04L 29/06; H04L 12/891

(52) U.S. Cl. CPC H04W 28/12; H04L 47/41; H04L 47/13; H04L 47/14; H04L 69/08; H04W 92/02

(57) ABSTRACT

An LTE cellular network and a WiFi network whose coverage areas overlap allow user devices accessing both networks to perform downlink channel aggregation through a tunneling feature provided by the cellular network whereby uplink information destined for the WiFi network is routed through an IP tunnel through the cellular network ultimately reaching the WiFi network via a common point or common network to which the WiFi and the cellular networks are connected. User devices having access to both networks are able to establish the tunnel during establishment of communications between such user devices and the WiFi network and use the tunnel as an uplink to convey information to the WiFi network, which is operated in a broadcast only mode or an ACK-less mode.

### FIELD OF THE INVENTION

The present invention generally relates to communication networks and in particular to aggregation of channels of different types of communication networks.

### BACKGROUND OF THE INVENTION

Local area networks are often limited in the coverage, range, bandwidth and throughput they provide to their subscribers. Inherently, local area networks, including wireless local area networks (WLAN), are typically designed to provide communication services in localized areas where such services are often freely accessible to the general public. Expectedly, during peak usage time periods, these LANs often reach their bandwidth capacity resulting in poor or inadequate service to users of such networks. With the ubiquitous nature of other types of wireless communication networks such as cellular communication networks, many of the users of LANs also have access to or subscribe to the cellular networks. Further, wireless cellular communication networks such as LTE (Long Term Evolution) networks (i.e., beyond 3G) are fine tuning their coverage with base stations (i.e., cell sites or eNodeBs in Beyond 3G LTE parlance) that cover relatively small areas heretofore uncovered (or heretofore inadequately covered) due to their awkward or inaccessible locations with respect to the coverage area of the network (i.e., beam coverage of the antennas of the network). Beyond 3G LTE networks are now using, Femto eNodeBs, Micro eNodeBs, and pico eNodeBs to ‘plug holes’ in their networks thereby improving the quality of experience and quality of service to their subscribers; for example, these improvements may serve to reduce the number of drop calls or significantly reduce calls with intolerable distortion. These latest improvements expose, however, the increasing incidences of overlaps in the coverage areas between, for example, wireless LANs and cellular communication networks.

A Wireless LAN transmits information to users situated in a localized area with the use of equipment commonly referred to as an AP (Access Point), which is also capable of receiving information from the same group of users. The user devices used to transmit information to the AP are often referred to as STAs (Stations). User devices transmit information to the AP via uplink channels and an AP transmits information to user devices via downlink channels. As more users attempt to use a WLAN, the overall throughput of the uplink channel often is adversely affected because of the limited capacity of the uplink of the WLAN. Further, the range of the uplink channel for a WLAN is typically a relatively short distance because the amount of uplink transmission power is typically quite limited. As a result, the coverage area of a WLAN is correspondingly quite limited. For cellular networks, however, user devices of subscribers transmit information to the cell sites over cellular uplink channels. These user devices for some of the cellular communication networks (e.g., Beyond 3G LTE networks, which is 3GPP rel. 8 or higher) are referred to as UE or (User Equipment). The cell sites transmit information to the UEs over downlink channels. Also, the uplink power and range of cellular networks are typically far greater than that of WLANs. Because the APs and some of the cell sites are increasingly covering the same areas (or many times there exist substantial overlaps in their respective coverage areas), it makes sense to consider integrating the two types of networks (e.g., WLANs and Beyond 3G LTE networks) to improve uplink capacity of the LANs, increase the throughput of the LANs, and generally operate the LANs in a manner that improves significantly the quality of service (QoS) and the quality experience (QoE) of their users.

Unfortunately, integrating the two types of networks to allow mutual usage of their respective systems and equipment in a seamless manner would require substantial modification of one or both networks. This is because each of the networks operates in very different fashions. In particular, each network uses different types of equipment transmitting and receiving information over different frequency ranges using different transmission and reception techniques. Further, each network operates in accordance with very different communication standards having totally different protocols.

### BRIEF SUMMARY OF THE INVENTION

The present invention provides a method, system and device that can be used in two different network types (i.e., a first type network and a second type network), which are operating under different standards and protocols and both types of networks are connected to a common point. The common point can be an interface (at both networks) to a public network enabling both networks to transfer and/or receive information to/from said public network. The common point can also be a third network that is accessible to the first and second networks. The term ‘interface’ refers to a logical entity that represents or can perform transfer of information from one network point (element or equipment) to another point of the same network or different network. A user device of the present invention, which can be used (simultaneously or at different times) in either of the two network types, is configured to initiate the establishment of communications with the first and second networks in accordance with their respective protocols. After having established communications with a first network type, the user device passively and/or actively scans for available networks of the second type that are able to convey information through a tunnel established within a first network type, and thus are able to share at least some of the resources of the first network type.

A user device having already established communications with a first type of network detects a second type of network through passive or active scanning. Upon detecting a second network type, the user device initiates the proper protocol session to establish communications with the detected network. In particular, the user device formats signaling information in accordance with the protocol of the first network, but embedded within this information are signaling information applicable to the second network (and destined for the second network) and which is formatted as per the protocol of the second network. That is, the embedded signaling information destined for the second network is encapsulated by signaling information associated with the first network and both types of information form a block of information that passes through the first network without being processed (by virtue of the encapsulating information).

The block of information ultimately arrives at the common point where it is transferred, by the first network, via an interface to the common point (e.g., a public network) where the information is then routed to its destination at the second network. The encapsulating information is stripped off at the destination point (i.e., the tunnel end point). That is, the route through the first network, to the common point (that may be a public network or a third network or an interface thereto) and then to the destination point at the second network is the tunnel. The second network, having now received an initial protocol message, transmits, via one of its channels (e.g., its downlink channel), a response directly to the user device. Alternatively, the second network may transmit its response back through the tunnel. Upon receipt of this response, the user device thus confirms the existence of an established tunnel through the first network. The user device continues to transmit second network signaling information via the tunnel and receives responses from the second network over the tunnel or over a channel of the second network, and thus eventually the user device establishes communications with the second network. Therefore, the user device has, at this point, established communications with a first type network and a second type network.

The term “established communications with a network” refers to a device or equipment having performed the various steps of a protocol (based on a standard being followed by the network) to allow the network to recognize and validate the device as a part of the network and allow the device to exchange signaling and/or traffic information with the network. Signaling information refers to information used by a network in the context of a procedure or protocol to manage communications and establish communications within its network elements and with devices or equipment that may or may not be part of its network elements. Traffic information refers to information being conveyed (transmitted and/or received) within a network or between a network and a device, system or other network where such information originate from other networks or from user devices who have established communications with the network. Examples of types of traffic information include, but are not limited, voice, video, multimedia, graphics, and text information.

The user device can now communicate with the first network and the second network, but its communication with the second network is done partially through the tunnel—eliminating the use of the uplink channel of the second network. In essence, because of the existence of the tunnel, the second network is able to share a transmit channel with the first network. That is, information—including traffic information (e.g., voice, video, text, multimedia) and signaling information destined for the second network are transmitted (but not processed or analyzed) through a tunnel in the first network in a seamless fashion (no disturbance or adverse affect on the operation of the first network) and ultimately are received by the second network via the common point. This arrangement allows the second network to provide more of its resources (transmit power, overall capacity, bandwidth and throughput) to its remaining channels (i.e., broadcasting or downlink channels) thus providing wider coverage, improved quality of service (QoS) and quality of experience (QoE) to its users.

In one embodiment, the first network is a cellular communication network, the second network is a Wireless LAN, the resources being shared is the uplink of the cellular communication network and the common point is a public network such as the Internet or an interface to the Internet or other network.

In another embodiment, the first network is a Beyond 3G LTE network, the second network is a WiFi network (i.e., operates in accordance with the 802.11 standard and associated protocols), the resources being shared is the uplink channel of the Beyond 3G LTE network and the common point is the Internet. The common point can also be a network other than the Internet which is interfaced to the LTE and WiFi networks.

In yet another embodiment, the user device uses an MPTCP (Multi-path TCP or Multi-path Transmission Control Protocol) agent to format and route information through the tunnel established within the first network type or via the direct path (i.e., uplink interface) to the common point (interface between first network and common network) in the first network type. For the path from the common point or common network, there is another MPTCP agent or proxy that allocates and distributes flow of information between a first interface to the first network and second interface to the second network and ultimately to the user device. The terms ‘proxy’ and ‘agent’ used with respect to the term ‘MPTCP’ will be used interchangeably. In this embodiment, with the uplink channel of the first network being shared by both networks, all of the downlink information to be transmitted to the user device from the second network can be done over the downlink channel of the second network. Alternatively, a portion of the information can be transmitted over the downlink channel of the second network and the remaining portion can be transmitted over the downlink channel of the first network. Specifically, when the second network has a certain amount of information (i.e., traffic information) to transmit over the downlink channel, the MPTCP agent can control the flow and distribution of the information. For example, a portion of the information is caused to be routed back through the tunnel and signaling information appended (by the second network) to this portion information will instruct the first network to transmit this portion over its downlink to the user device. The remaining portion of the information can be transmitted by the second network over its downlink channel. Thus, downlink channel aggregation is achieved whereby both networks are transmitting related information over their respective downlink channels.

### BRIEF DESCRIPTION OF THE DRAWINGS

FIG. 1 shows portions of a first network and a second network both of which operate in accordance with different communication standards and protocols.

FIG. 2 shows a call flow diagram of how MPTCP proxies setup and allocate flow of data through the first and second networks.

FIG. 3 is a flow chart of the method of the present invention as performed by a user device.

FIG. 4 is a flow chart of the method of the present invention as performed by the first network.

FIG. 5 is a flow chart of the method of the present invention as performed by the second network.

### DETAILED DESCRIPTION

The present invention provides a method, system and device that can be used in two different network types (i.e., a first type network and a second type network), which are operating under different standards and protocols and both types of networks are connected to a common point. The common point can be an interface (at both networks) to a public network enabling both networks to transfer and/or receive information to/from said public network or to/from a third network that is accessible to the first and second networks. The common point can also be a third network that is accessible to the first and second networks. The term ‘interface’ refers to a logical entity that represents or can perform transfer of information from one network point (element or equipment) to another point of the same network or different network. A user device of the present invention, which can be used (simultaneously or at different times) in either of the two network types, is configured to initiate the establishment of communications with the first and second networks in accordance with their respective protocols. After having established communications with a first network type, the user device passively and/or actively scans for available networks of the second type that are able to convey information through a tunnel established within a first network type, and thus are able to share at least some of the resources of the first network type.

A user device having already established communications with a first type of network detects a second type of network through passive or active scanning. Upon detecting a second network type, the user device initiates the proper protocol session to establish communications with the detected network. In particular, the user device formats signaling information in accordance with the protocol of the first network, but embedded within this information are signaling information applicable to the second network (and destined for the second network) and which is formatted as per the protocol of the second network. That is, the embedded signaling information destined for the second network is encapsulated by signaling information associated with the first network and both types of information form a block of information that passes through the first network without being processed (by virtue of the encapsulating information). The routing of the information through the first network is based on instructions from the encapsulating information.

The block of information ultimately arrives at the common point where it is transferred, by the first network, via an interface to the common point (e.g., a public network) where the information is then routed to its destination at the second network. The encapsulating information is stripped off at the destination point (i.e., the tunnel end point). That is, the route through the first network, to the common point (that may be a public network or a third network or an interface thereto) and then to the destination point at the second network is the tunnel. The second network, having now received an initial protocol message, transmits, via one of its channels (e.g., its downlink channel), a response directly to the user device. Alternatively, the second network may transmit its response back through the tunnel. Upon receipt of this response, the user device thus confirms the existence of an established tunnel through the first network. The user device continues to transmit second network signaling information via the tunnel and receives responses from the second network over the tunnel or over a channel of the second network, and thus eventually the user device establishes communications with the second network. Therefore, the user device has, at this point, established communications with a first type network and a second type network.

The term “established communications with a network” refers to a device or equipment having performed the various steps of a protocol (based on a standard being followed by the network) to allow the network to recognize and validate the device as a part of the network and allow the device to exchange signaling and/or traffic information with the network. Signaling information refers to information used by a network in the context of a procedure or protocol to manage communications and establish communications within its network elements and with devices or equipment that may or may not be part of its network elements. Traffic information refers to information being conveyed (transmitted and/or received) within a network or between a network and a device, system or other network where such information originate from other networks or from user devices who have established communications with the network. Examples of types of traffic information include, but are not limited, voice, video, multimedia, graphics, and text information.

The user device can now communicate with the first network and the second network, but its communication with the second network is done partially through the tunnel—eliminating the use of the uplink channel of the second network. In essence, because of the existence of the tunnel, the second network is able to share a transmit channel with the first network. That is, information—including traffic information (e.g., voice, video, text, multimedia) and signaling information destined for the second network are transmitted (but not processed or analyzed) through a tunnel in the first network in a seamless fashion (no disturbance or adverse affect on the operation of the first network) and ultimately are received by the second network via the common point. This arrangement allows the second network to provide more of its resources (transmit power, overall capacity, bandwidth and throughput) to its remaining channels (i.e., broadcasting or downlink channels) thus providing wider coverage, improved quality of service (QoS) and quality of experience (QoE) to its users.

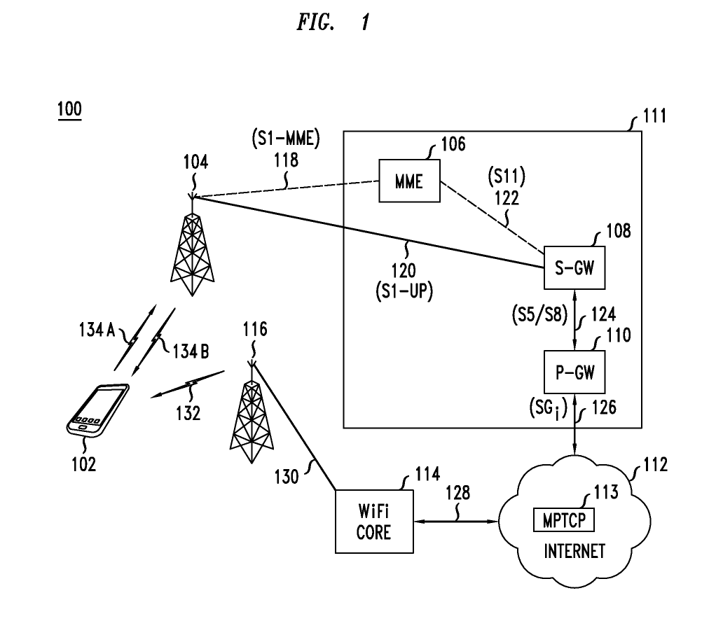

Referring now to FIG. 1, there is shown a portion of a Beyond 3G LTE cellular network (eNodeB 104, Core network 111 and associated interfaces) a portion of a WiFi network (AP 116 and Core 114 and associated interfaces) connected at a common point, Internet network 112, via interfaces 126 and 128. For the sake of explanation, the first network is the Beyond 3G LTE network and the second network is the WiFi network. It is clearly understood, however, that the first and second networks can be other types of networks. An MPTCP (Multi-Path Transmission Control Protocol) proxy (or agent)_113 for controlling flow of information is shown located in the Internet and will be discussed infra. A user device 102 allows a user and/or subscriber to the

WiFi and LTE networks respectively to gain access to both networks and operate within both networks simultaneously or separately. The user device 102 also uses an MPTCP (not shown) to control the flow of information as will be discussed infra. One example of a user device 102 is a smart phone that can gain access to both the LTE network and the WiFi network simultaneously or separately. Other examples of such devices include, but are not limited to, laptops, tablets, and notebooks. Functions associated with the WiFi and LTE networks are integrated within user device 102. However, it should be well understood that the present invention also applies to user device 102 being two separate devices interfaced in some manner to each other where one device (e.g., a laptop) is capable of establishing and maintaining communications with the WiFi network and the other device, a smart phone, is capable of establishing and maintaining communications with the Beyond 3G LTE cellular network. For ease of explanation, however, the description of FIG. 1 will denote user device 102 as a single device, viz., UE/STA 102. The terms UE/STA and user device will be used interchangeably.

As previously discussed, the uplink of the WiFi network can quickly become overburdened as more users join the WiFi network. The present invention allows for sharing of the uplink channel of the LTE network and aggregation of the downlink channels of the LTE and the WiFi networks through the use of tunneling whereby the UE/STA 102 transmits uplink information (signaling and/or traffic information) destined for AP 116 over the uplink channel 134A of the LTE network which routes said information through its various interfaces in seamless fashion (i.e., without processing the information and without disturbing its own operation) to the common point 112 and ultimately the information is routed to AP 116; in this manner, the information is said to be routed through a tunnel through the LTE network and ultimately to the WiFi network. Thus, the WiFi network shares the uplink of the LTE network in seamless fashion. The uplink channel of the AP 116 is not used at all allowing the AP 116 to use any of its resources not used for its uplink channel to operate in a Broadcast-only mode or an ACK-less mode as will be described infra.

The UE/STA 102 device has an MPTCP agent (not shown) that operates in conjunction with a counterpart MPTCP proxy 113 located at the common point (i.e., the Internet or other common network to LTE and WiFi networks) to control the flow of information within the tunnel and outside of the tunnel as will be now be explained. The MPTCP proxies can be implemented with firmware or software residing in a user device or in a server that part of a communication network to direct the flow and distribution of information. Flow of information in both directions within the tunnel and outside of the tunnel is being controlled by the MPTCP proxies. It is to be noted that the flow of traffic information originate from the MPTCPs.

The downlink channels of the LTE network and the WiFi network can both be used where each is allocated a portion of downlink information to be transmitted to the user device. The allocation and/or distribution of information are controlled by the MPTCP proxy (not shown) at UE/STA 102 and its counterpart proxy 113 located within Internet 112. For example, all of the downlink information from AP 116 can be transmitted over the WiFi downlink channel 132. In the alternative, a portion of the flow can be transmitted over downlink channel 132. The other portion of the information flow is controlled by MPTCP proxy 113, which directs the flow of the information over interface 126 through the tunnel in LTE network core 111 to eNodeB 104 and ultimately over LTE downlink 134B to UE/STA device 102. In this manner, downlink aggregation can be achieved between the two networks. This is done through the negotiations between the two MPTCP proxies (during the establishment of communications and the establishment of the tunnel) to determine how the downlink information is to be distributed between the tunnel (and ultimately the LTE downlink channel 134B) and the WiFi downlink channel 132.

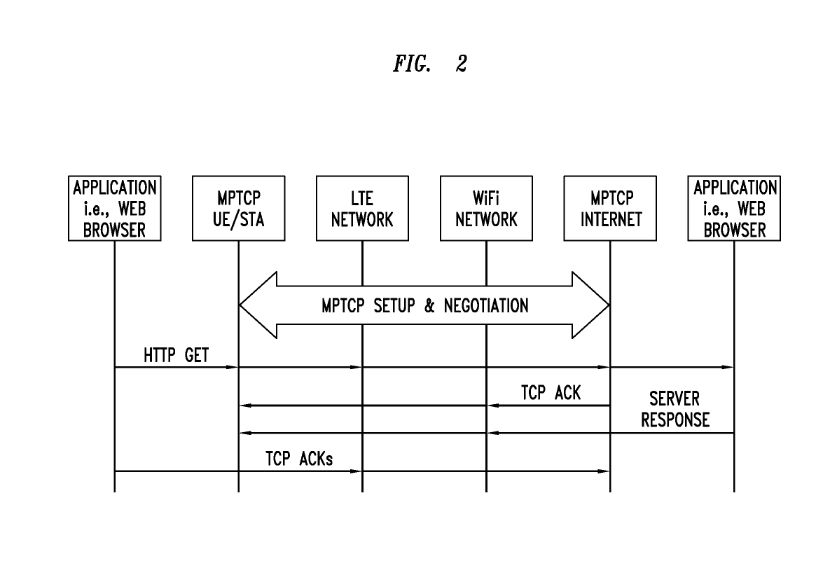

Referring temporarily to FIG. 2, there is shown a call flow diagram of how the two MPTCP agents (agent 113 at the Internet and another agent at UE/STA 102 (not shown)) establish the proportionate flow of information (i.e., distribution of information) between two applications via the LTE and WiFi networks. WiFi network entities STA 102, AP 116 Core 114 are simplified to WiFi Network in the call flow diagram. Also, LTE network entities UE 102, S-GW 108, MME 106 and P-GW 110 are simplified to LTE Network in the call flow diagram. The MPTCP setup and negotiation take place after the establishment of communications (during which the tunnel is also being established) between UE/STA 102 and the WiFi network. In the example shown in the call flow diagram, UE/STA 102 is accessing an application residing in the Internet via the tunnel; this necessarily involves MPTCP 113 because it directly affects and controls flow of information in the tunnel. MPTCP 113 transmits an ACK signal (using Transmission Control Protocol) via the tunnel upon receiving the HTTP Get request (request to access the Internet) from UE/STA 102 via the tunnel—HTTP is Hyper Text Transfer Protocol. The site (i.e., a server) in the Internet being accessed is routed through MPTCP 113 and thus agent 113 appears as the originator of information (i.e., traffic information from the Internet). The application being accessed responds with information that is passed through the tunnel and received by the originating application. The MPTCP at the UE/STA) receives the information transmitted through the tunnel.

In general, any portion of downlink information—say, for example, from a Web browser accessed via the WiFi network can be transmitted over the WiFi downlink channel 132 and another portion of the same information can be transmitted over the tunnel to the LTE downlink channel 134B thus performing downlink channel aggregation between two different networks. In a simpler case, all of the uplink information from an application can be tunneled through the uplink of the LTE network and all downlink information is provided to the AP 116 for transmission over WiFi downlink channel 132. The tunnel can be referred to as an IP tunnel when the common network between the two networks is the Internet.

Referring back to FIG. 1, the WiFi network, as shown, comprises WiFi AP 116 interfaced to its core 114 via communication link 128. The Core 114 in combination with AP 116 comprises servers and other equipment that process signaling information (and traffic information) from a user device (i.e., a STA or in this example, a UE/STA 102) to authenticate the user device and also associate the user device to the WiFi network and ultimately establish communications between the user device and the WiFi network. The Core 114 and AP 116 also route traffic information between the WiFi network and a user device either via WiFi downlink channel 132 or via the tunnel through the LTE network. As with most networks, the Core 114 is the central component(s) that performs handshaking protocols (i.e., exchanging signaling information with a STA) to establish communications with a device such as UE/STA 102. The WLAN core 114 is also connected to the Internet 112 via interface 128. WiFi AP 116 transmits information (signaling and traffic information) to the UE/STA 102 (and other devices) over downlink 132. The user device, UE/STA 102, in turn, does not transmit information to AP 116 over an uplink channel of the WiFi network as would normally be the case. Instead, UE/STA 102 first formats the message that it intends to send to AP 116 and then transmits the message to eNodeB 104 over LTE uplink 134A as per rules and protocols of the standard being followed by the LTE network. The formatting is done to notify or instruct the LTE network not to process this information, i.e., shield the information from any processing by the LTE network as it flows through the LTE network.

Further, the formatting of the message comprises the user device encapsulating the message (attaching information at the beginning and end of the message) to cause the LTE network not to process the encapsulated block of information and route it seamlessly (i.e., without disturbing any processing or routing of LTE related signaling and traffic information that may be occurring) through the various interfaces of the LTE network. In particular, initially UE/STA 102, having already established communications with the LTE network, would now want to establish communications with the WiFi network. Accordingly, UE/STA 102 transmits over uplink 134A to eNodeB 104 an encapsulated ‘authentication request’ destined for AP 116 of the WiFi network. It should be noted that at the same time, the LTE network may be transmitting LTE related information over its downlink 134B or receiving LTE related information over its uplink 134A from the same user device, i.e., UE/STA 102. The ‘authentication request’ may be routed through the S1-MME interface 118 to the MME (Mobility Management Entity) 106, the S11 interface 122 to S-GW (Serving Gateway) 108, the S5/S8 interface to the P-GW 110 (PDN Gateway or Packet Data Network Gateway), the SGi interface 126 to the Internet 112 routed through to the interface 128 then to the WiFi core 114 and ultimately to AP 116 via interface 130. The information reaches AP 116 because in formulating and formatting the information, the UE/STA 102 inserted the AP's IP address as the destination address of the information. MPTCP 113, as described supra, may or may not be used to effect the distribution of information (routed as described above) destined for AP 116. Also, the encapsulated information may alternately be routed over the S1-UP interface 120 to S-GW 108 instead of being routed via the S1-MME and S11 interfaces as discussed above.

AP 116—having received the authentication request—transmits, over its downlink 132, an authentication request response to UE/STA 102. Having received the authentication request response from AP 116, the UE/STA 102 thus confirms the establishment of a tunnel (e.g., an IP tunnel) through the LTE network.

UE/STA 102 will then send over the tunnel any additional signaling information (as per the 802.11 protocol) needed to complete the establishment of communications between it and the WiFi network. Once communications are established, UE/STA 102 and AP 116 can exchange traffic information as per the 802.11 protocol where information from the UE/STA 102 to AP 116 is transmitted over the tunnel established within the LTE network as described above and information from AP 116 to the UE/STA 102 is transmitted by AP 116 over the downlink channel 132 of the WiFi network. Also, with the use of MPTCP proxies as described above, part of the WiFi network downlink information may be transmitted over the tunnel to the UE/STA 102 instead of having the AP 116 transmit all of the downlink information over WiFi downlink channel 132.

In this mode of operation where tunneling is being used, the WiFi AP 116 can be operated in a ‘Broadcast only’ mode or operated in an ACK-less mode. Both modes can be interpreted as open loop modes in that in either mode, the AP 116 does not expect (and will not receive) an ACK message from any STA (in this example, UE/STA 102) confirming that the broadcast information was properly received. In Broadcast only mode, AP 116 broadcasts over downlink 132 in response to information it receives via the tunnel. The broadcast information is a multi-cast; that is, the broadcast information is formatted so that it can be received by a plurality of user devices. The AP can also be operated in an ACK-less mode as per 802.11(e) protocol. In the ACK-less mode, the information broadcast by AP 116 is intended for a particular user device; that is, it is a unicast. Thus, the AP 116 broadcasts information in response to requests made by user devices where such requests were made via the tunnel. User devices operating as per one of the method of the present invention are thus able to exploit the uplink of the LTE network to improve the capacity, coverage and Quality of Experience (QoE) of the WiFi network. In particular, the transmit power and transmit range of the Wi-Fi network is significantly increased because the user devices for the Wi-Fi network, in essence, are using the uplink of the LTE network instead of the uplink of the WiFi network.

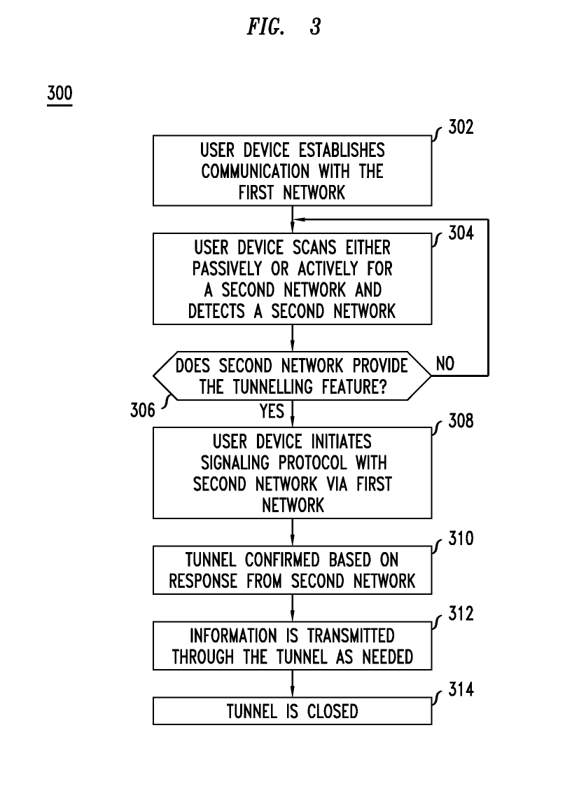

Referring now to FIG. 3, a flow chart 300 of the method of the present invention performed by a user device is shown. The method performed by the user device will be described in the context of the first network being an LTE wireless cellular network, the second network being a WiFi network and the user device being a UE/STA device (e.g., a smart phone with WiFi capabilities) capable of establishing communications with both networks. A smart phone is typically a cellular phone with various features related to downloaded apps that use the network to provide services to the user other than simply voice services. Most smart phones in addition to having access to the Internet through the cellular network are also capable of accessing the Internet via a WiFi Network. In step 302, UE/STA 102 establishes communications with the first network (i.e., the LTE network). In step 304 UE/STA 102 actively and/or passively scanning for a local network (i.e., a WLAN) detects this second network. The second network may be broadcasting its presence and capabilities via a beacon accessible by user devices. WLANs such as WiFi networks typically transmit such beacons advertising their presence and any special features that may be available. As a result of the transmission of the beacon, UE/STA 102 may passively detect such beacon. Alternatively, UE/STA may transmit a probe SSID (Service Set Identifier) request to actively scan its immediate area for a WiFi network. Further, the UE/STA 102 may be actively scanning for a particular network capable of operating through a tunnel in another network.

In step 306, UE/STA 102 determines whether the detected network is one that provides the tunnel feature. UE/STA can, for example, make this determination by processing the beacon signal, which may have information about various features of the WiFi network. If the user device does not detect a network with the tunneling feature, a first option is for the user device to continue to seek a second network providing the tunneling feature for a defined period of time. After said period of time lapses, the user device may decide to access an available network regardless of whether such available network provides the tunneling feature. A second option is for the user device to continue to search for a second network with the tunneling feature and thus return to step 304; the second option is shown by the flow chart.

In step 308, UE/STA 102 has found a WiFi network that provides the tunneling feature and has initiated a handshaking protocol to establish communications with that WiFi network. For example, in establishing communications with the WiFi network, the UE/STA 102 first transmits an authentication request to the WiFi network. The authentication request allows a user device (station) to establish its identity with an Access Point (say AP 116). Upon reception of an authentication response from the AP 116, the UE/STA 102 transmits an association request, which starts the process of the UE/STA 102 registering with the WiFi network to gain full access to the WiFi network. The UE/STA 102 transmits signaling information (e.g., authentication request, association request) destined for the WiFi network over the uplink channel of the LTE network whereby prior to transmission the UE/STA 102 formats such information with LTE signaling information; this causes the LTE network to route the information through the core network 111 and not to process such information in any manner as discussed infra. Specifically, the UE/STA 102 encapsulates the signaling information intended for the WiFi network with LTE signaling information resulting in a block of WiFi signaling information encapsulated with LTE signaling information. The terms ‘format’ or ‘formatting’ of the information refers to the arrangement of various portions of the information and attachment of signaling information to the information as per the protocol(s) of one or more communication networks through which the information will travel. One type of formatting that is done to the information is encapsulating it with signaling information. The term encapsulating refers to a type of formatting where signaling information is attached to the beginning and end of a block of information. The information sent through the tunnel by UE/STA 102 can be signaling or traffic information or both; in any case, the information is encapsulated by signaling information associated with the LTE network and the common network or common point (in our case, the Internet 112) to allow for proper routing of the information. The core network 111 transfers the information to Internet 112, which then routes the block of information to its destination through interfaces 128, to core 114, interface 130, and AP 116; at this point the tunnel has been established. The tunnel can be referred to as an IP tunnel in cases where signaling information from the Internet Protocol is included in the blocks of information traveling through the tunnel. The encapsulating information is stripped off by AP 116, which then sends a response back to the UE/STA 102 either via downlink 312 or back through the tunnel (with proper signaling information) to allow the LTE to transfer it to UE/STA via downlink channel 134B.

In step 310, UE/STA 102 confirms the establishment of the tunnel upon reception of the response from AP 116. UE/STA 102 continues with the handshaking protocol to establish communications with the WiFi network. Once communications are established, UE/STA 102, in step 312, is able to exchange traffic information with the WiFi network using the tunnel as an uplink channel and using downlink channel aggregation as discussed supra. Information transmitted through the tunnel may be signaling and/or traffic information. Further, some of the downlink information being received by UE/STA 102 may be routed through the tunnel to eNodeB 104 and over LTE downlink 134B to UE/STA 102 as a result of downlink channel aggregation planned and orchestrated by the MPTCP proxies (113 and the one at UE/STA 102) as discussed supra.

In step 314, the UE/STA 102 terminates the communication to the WiFi network and in effect, closes the tunnel. Resources previously reserved by the LTE network for maintaining the existence and proper operation of the tunnel are now available for use for other purposes by the

LTE network. The UE/STA 102 closes the tunnel by either a timeout, a disassociate command being sent over the tunnel by the UE/STA 102, or the WiFi interface 130 being disassociated with the attached AP 116.

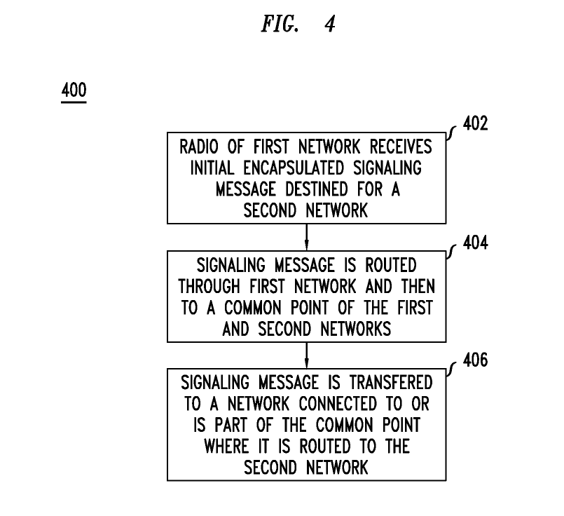

Referring now to FIG. 4, which shows a method 400 of the present invention as performed by the first network (i.e., the LTE network in our example). In the example depicted by FIG. 1, the first network has its uplink shared with the second network through the use of a tunnel established by a user device (e.g., UE/STA 102) having access to both networks. The user device, after having established communications with the first network, initiates transmission of signaling information (i.e., a block of information) to establish communications with the second network and in doing so also establishes the tunnel through the first network (i.e., the LTE network). Initially, in step 402, equipment of the LTE network (i.e., a radio at eNodeB 104, and/or equipment at the eNodeB 104 and core 111) receives signaling information from UE/STA 102 and transfers the information to MME 106 via the S1-MME signaling interface 118. The received signaling information is actually a block of information comprising signaling information intended for the WiFi network encapsulated by signaling information for the LTE network.

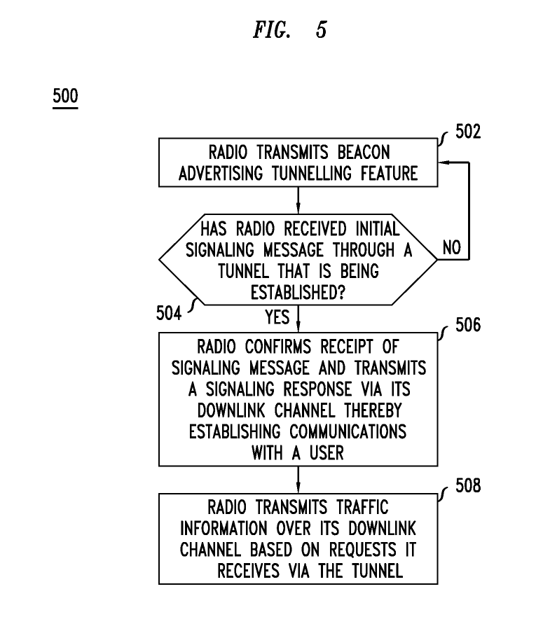

MME 106 interprets the received signaling information (i.e., the encapsulating signaling information) and in step 404 determines that it is to be routed through core network 111 without any processing. In step 406 P-GW 110 transfers the received information to the common point (i.e., the Internet 112 or a point common to first and second network that is connected to Internet 112) via the SGi interface 126. Alternatively, the eNodeB 104 is able to determine that the signaling information received from UE/STA 102 is a special type of signaling information that is to be routed through the core network 111 with its encapsulating information and transferred to the common point (e.g., Internet 112). As such, eNodeB 104 routes this information to the S-GW 108 via the S1-UP interface 120 which then routes the information to the P-GW 110 via the S5/S8 interface 124; the P-GW 110 transfers it to the common point via interface 126. Other signaling information and traffic information having the same instructions will be routed and processed in the same manner as this initial signaling message. It is to be noted that the encapsulating information is stripped off at the tunnel endpoint (i.e., AP 116 or alternatively UE/STA 102) upon the information reaching its destination as will now be discussed with respect to FIG. 5.

Referring now to FIG. 5 wherein a method 500 of the present invention as performed by the second network (e.g., the WiFi network) is shown. In step 502 AP 116, comprises a radio (and/or other equipment of the WiFi network) that is transmitting a beacon signal to indicate, inter alia, its tunneling feature to potential users. AP 116 is also advertising its presence to would be users of its network in a periodic fashion or in response to a probe signal from a potential user. In step 504, AP 116 is checking to see if the core 114 has received any initial signaling message from a new user through a tunnel that is being established. AP 116 has turned off its uplink channel and expects to receive signaling information via a tunnel to its core network 114, which would indicate that a potential user is in the process of establishing communications and establishing a tunnel via another network (e.g., the LTE network). AP 116 is thus continuously monitoring for such a message. Upon receipt of an initial signaling message, the method 500 of the present invention as performed by AP 116 of the WiFi network moves to step 506 where AP 116 confirms reception of a protocol message from a potential user in the process of initiating the establishment of communications and the establishment of a tunnel through another network (such as, for example an LTE network). AP can either transmit its response over its downlink channel (e.g., downlink channel 132 in FIG. 1) or transmit its response via the tunnel and such response is transmitted over downlink 134B of the first network (i.e., the LTE network). In step 508, AP 116 continues to receive signaling information and eventually traffic information for transmission on its downlink channel. At some point, the tunnel will have been closed by the UE/STA 102 which initiated the establishment of communications. As a result, AP 116 will no longer receive any communications from core network 114 for that particular user until such user re-establishes communications at some later time.

While various aspects of the invention have been described above, it should be understood that they have been presented by way of example and not by limitation. It will be apparent to persons skilled in the relevant art (s) that various changes in form and detail can be made herein without departing from the spirit and scope of the present invention. Thus, the present invention should not be limited by any of the above-described exemplary aspects, but should be defined only in accordance with the following claims and their equivalents.

What is claimed is:

1. A method performed by a user device, the method comprising:
establishing, by the user device, communications with a first network;
transmitting, by the user device, initial signaling information intended for a second network which initial signaling information is formatted by the user device such that it establishes a tunnel through the first network; and
establishing, by the user device, communications with the second network through the established tunnel.

2. The method of claim 1 wherein the step of establishing communications with the first network comprising the user device scanning for a network that provides a tunneling feature.

3. The method of claim 1 wherein the step of transmitting initial signaling information intended for the second network comprises the user device encapsulating the initial signaling information with signaling information associated with the first network.

4. The method of claim 1 where the step of establishing communications with the second network through the established tunnel comprises:
receiving, by the user device, from the second network the initial signaling information;
stripping, by the user device, the encapsulating information from the received signaling information; and
transmitting, by the user device, responses to the received initial signaling information and other received signaling information.

5. The method of claim 1 wherein the first and the second network are connected to each other via a common point.

6. The method of claim 5 wherein the common point is a public network.

7. The method of claim 6 wherein the public network is the Internet.

8. The method of claim 1 wherein the first and second networks are different types of networks that follow different communication standards with different protocols.

9. The method of claim 1 wherein the first network is a cellular communication network and the second network is a WLAN.

10. The method of claim 9 wherein the cellular network is a Beyond 3G LTE network and the WLAN network is a WiFi network.

11. The method of claim 10 wherein the user device is a smartphone capable of establishing communications with the Beyond 3G LTE network and the WiFi network where the smart phone transmits information to the WiFi network via the tunnel and the smart phone receives information from the WiFi network over a downlink channel of the WiFi network.

12. The method of claim 1 wherein the first network and the second network following different communication standards and have different protocols.

13. The method of claim 1 wherein the user device is capable of establishing communications with the first and second networks simultaneously or at different times.

14. The method of claim 1 wherein the user device has an MPTCP agent function that allocates and distributes flow of information through the tunnel and directly to its destination via an interface to a common point between the first and second networks.

15. A method performed by a first network, the method comprising:
receiving, by equipment of the first network, initial encapsulated signaling information destined for a second network;
routing, by equipment of the first network, the received signaling information to a common point between the first and second networks; and
transferring by equipment of the first network, the initial signaling message from the common point to another network via an interface to the other network.

16. The method of claim 15 further comprising routing additional signaling information and traffic information from the common point to the other network via the interface.

17. The method of claim 15 wherein the other network is the Internet.

18. The method of claim 15 wherein the routing of the received signaling information is based on encapsulation information appended to the signaling information.

19. A method performed by a second network, the method comprising:
transmitting, by equipment of the second network, a beacon signal advertising a tunneling feature;
transmitting, by equipment of the second network, a response to an initial signaling message received via a tunnel in the second network; and
transmitting, by equipment of the second network, additional received signaling information and traffic information received via the tunnel.

20. The method of claim 19 wherein the second network is a WiFi network.

21. The method of claim 20 where the equipment transmits information over a downlink channel of the WiFi network.

22. The method of claim 1 where an equipment at a common point to the first and second networks allocates and distributes flow of information through the first and second networks to the user device.
